(19) United States
(12) Patent Application Publication
(10) Pub. No.: US 2004/0049459 A1
(43) Pub. Date: Mar. 11, 2004

(54) System and method for integrated electronic invoice presentment and payment

(76) Inventors: Philip J. Philliou, Haworth, NJ (US); Shari L. Krikorian, Armonk, NY (US); Edward F. Downs, River Vale, NJ (US); Jared Levin, Thornwood, NY (US)

Correspondence Address: BAKER & BOTTS, 30 ROCKEFELLER PLAZA, NEW YORK, NY, 10112

(21) Appl. No.: 10/465,394

(22) Filed: Jun. 18, 2003

Related U.S. Application Data
(60) Provisional application No. 60/389,659, filed on Jun. 18, 2002.
(60) Provisional application No. 60/391,905, filed on Jun. 27, 2002.

(51) Int. Cl. G06F 17/60

(52) U.S. Cl. 705/40

(57) ABSTRACT

A system and method is provided for an electronic invoice presentment and payment management service. The system and method automatically link electronic purchase orders, invoices, receipt-of-goods documents, and other transaction-related information to a payment card transaction, such as a purchasing card transaction. The system may be used in conjunction with existing infrastructure and the systems currently employed by a buyer organization and a supplier organization. The system provides for the delivery of Level III data (invoice detail) with every payment card transaction and automatically inputs this Level III detailed transaction data into the buyer's accounts payable system and enterprise resource planning system.

### CROSS-REFERENCE TO RELATED APPLICATIONS

This application claims priority to the following provisional applications which are incorporated herein by reference in their entirety: U.S. Provisional Patent Application No. 60/389,659, entitled “System And Method For Integrated Electronic Payment And Information Infrastructure Between Financial Institutions And Other Organizations,” filed on Jun. 18, 2002; and U.S. Provisional Patent Application No. 60/391,905, entitled “Improved System And Method For Integrated Electronic Payment And Information Infrastructure Between Financial Institutions And Other Organizations,” filed on Jun. 27, 2002.

### BACKGROUND OF THE INVENTION

Conventional invoicing and payment collection systems involve labor intensive, paper-based, manual processes for businesses and other organizations. Typically, an invoicer (i.e., the supplier) prepares a paper invoice detailing the goods and services provided to a buying organization, including the charges associated therewith. The invoice is mailed to the buying organization, and the buying organization then verifies the accuracy of the invoice by matching it against a purchase order (PO) previously generated by the buyer for the purchase and a receiver document generated at the time of receipt of the goods or services (a process known as the “three-way match”). Once the invoice is verified, the buying organization sends payment, usually in the form of a paper check through the mail, to the invoicer. The invoicer then submits the paper check to its bank for payment.

Paper payment systems require the buying organization to send the paper check to the invoicer's bank either directly through the invoicer or indirectly to a lock box before payment is made from the buying organization's bank to the invoicer's bank. This exchange is inefficient, requiring multiple steps and unnecessary delay to compensate the invoicer for goods or services rendered.

Attempts have been made to automate the invoicing process through the use of third-party service providers. Early electronic invoice presentment and payment (EIPP) solutions, however, focused on the needs of the supplier (biller) and did not adequately address the needs of the buyer (payer). For example, many early EIPP solutions did not address the payment-related needs of the buyer (payer), such as to efficiently and effectively control the initiation of payments, defer their settlement, and reconcile and integrate them into the buyer's financial systems.

Furthermore, existing EIPP systems have not typically utilized payment cards (such as credit cards, debit cards, corporate cards, and purchasing cards) as a means of business-to-business payments. Moreover, these EIPP systems have not allowed the use of payment terms associated with payment by payment cards or the validation of buyer invoicing rules prior to payment by payment card.

Furthermore, existing EIPP systems are not capable of automated integration of payment card data into an organization's internal systems, such as its enterprise resource planning (“ERP”) system or accounts payable (“A/P”) system. Accordingly, organizations are forced to manually re-key invoice data, match it with the card transaction for reconciliation purposes, and then manually enter the data into the organization's ERP or A/P system. This process is time consuming and prone to human error.

Some existing EIPP systems may utilize financial electronic data interchange (EDI) or other electronic payment technologies. However, these payment methods may require significant set-up costs, including costly changes to internal systems and processes, and may require changes in banking relationships as well.

Thus, there exists a need for an improved electronic invoicing presentment and payment system that is cost-effective, simple to integrate into existing processes and systems, and allows efficient payment and reconciliation of financial records.

### SUMMARY OF THE INVENTION

Accordingly, it is an object of the present invention to fulfill a need in the field of invoice presentment and payment (“EIPP”) by providing systems and methods for integrated electronic invoice presentment and payment. One exemplary method includes the steps of receiving a purchase order from a buyer, the purchase order including payment card account information and settlement date information, receiving an invoice from a seller related to the purchase order, receiving an indication of approval of the invoice from the buyer, and masking the payment card account information, in whole or in part, from the seller until the settlement date.

Another exemplary method includes the steps of receiving an invoice from a seller, receiving an indication of approval of the invoice from a buyer, including payment card account information and settlement date information, and masking the payment card account information, in whole or in part, from the seller until the settlement date.

Another exemplary method includes the steps of receiving a purchase order from a buyer, the purchase order including payment card account information, receiving an order confirmation or invoice from a seller related to the purchase order, validating the order confirmation or invoice against predetermined buyer-defined rules, and masking the payment card account information, in whole or in part, from the seller until the order confirmation or invoice has successfully satisfied the buyer-defined rules.

Another exemplary method includes the steps of receiving a purchase order from a buyer, the purchase order including payment card account information, the payment card account information being used to provide payment for the transaction through a payment network, receiving an order confirmation or invoice from a seller related to the purchase order, and matching information in the purchase order, order confirmation or invoice, and payment record for the payment card transaction to provide Level III data.

Another exemplary method comprises providing an electronic invoice presentment and payment system for receiving an electronic purchase order from a buyer and transmitting the purchase order information to a supplier. The purchase order preferably includes information related to the transaction and to the proposed payment for the transaction (e.g., a payment card).

Another exemplary method includes providing an electronic invoice presentment and payment system (EIPPS) for receiving an electronic purchase order from a buyer and transmitting the purchase order (PO) to a supplier. The purchase order preferably includes information related to said transaction and to the purchasing card. The steps further include: receiving from the supplier an electronic invoice, transmitting data related to the PO to a payment card network for authorization of said transaction, matching by the EIPPS either the purchase order or the invoice with a record provided by the payment card network, and storing by the EIPPS the detailed data related to the transaction and integrating at least a portion of the detailed data into the buyer's system.

Another exemplary method includes facilitating generation of an electronic invoice by the supplier using an electronic invoice presentment and payment system (EIPPS), receiving the electronic invoice from a supplier's system by the EIPPS, transmitting the electronic invoice from the EIPPS to a buyer, transmitting data associated with the transaction to a payment network to facilitate an electronic payment of the electronic invoice from the buyer to the supplier, matching data from the electronic invoice to the electronic payment, and automatically integrating the detailed data related to the transaction into the buyer's system.

Another exemplary system according to the present invention includes a first adapter subsystem coupled to a buyer organization financial system, a second adapter subsystem coupled to a supplier organization financial system, an EIPPS coupled to both the first and second adapter subsystem, and a data repository coupled to said EIPPS.

The accompanying drawings, which are incorporated and constitute part of this disclosure, illustrate preferred embodiments of the invention and serve to explain the principles of the invention.

### BRIEF DESCRIPTION OF THE DRAWINGS

Further objects, features, and advantages of the present invention will become apparent from the following detailed description taken in conjunction with the accompanying figures showing illustrative embodiments of the invention, in which:

FIG. 1 is a block diagram illustrating a system for a standard purchasing card transaction;

FIG. 2 is a block diagram showing an exemplary electronic invoice presentment and payment system in accordance with the present invention;

FIG. 3 is a flow chart showing an exemplary method for conducting an electronic invoice presentment and payment transaction in accordance with the present invention;

FIG. 4 is a flow chart showing an exemplary method for conducting an electronic invoice presentment and payment transaction in accordance with the present invention;

FIG. 5 is a flow chart showing an exemplary method for conducting an electronic invoice presentment and payment transaction in accordance with the present invention.

Throughout the figures, unless otherwise stated, the same reference numerals and characters are used to denote like features, elements, components, or portions of the illustrated embodiments.

### DETAILED DESCRIPTION OF THE INVENTION

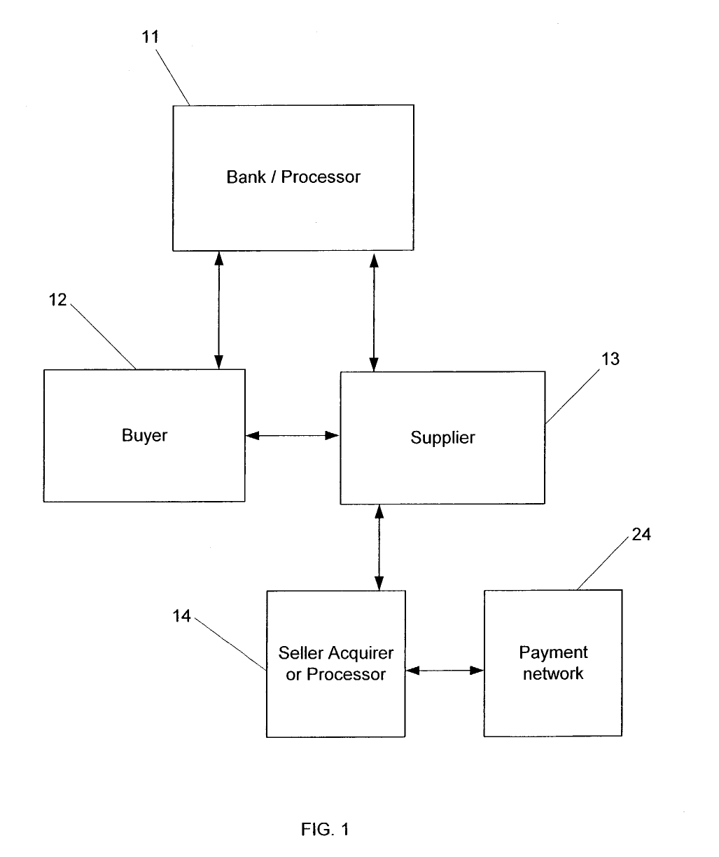

Referring to FIG. 1, an exemplary system for conventional purchasing card transactions 10 is shown. A buying organization 12 places an order with a supplier organization 13 using a purchasing card. The supplier organization then sends an authorization request for the purchase to the issuing bank 11 which issued the purchasing card through the supplier's acquirer bank or processor 14 which is connected to a payment network 24 (such as the MasterCard payment network). If the authorization request is approved, the supplier organization 13 then ships the goods to buyer organization 12. After the goods are shipped, the supplier organization 13 submits data regarding the purchase to the acquirer bank or processor 14 and the bank or processor clears and settles the transaction through the payment network 24.

By way of background, MasterCard's purchasing card (i.e., “P-Card”) was first introduced in 1993 to provide organizations with an improved means for expense management. Key benefits of the P-Card are that it 1) provides convenience, 2) reduces paperwork, 3) allows management to exert greater control through the card's authorization system, 4) is accepted by merchants worldwide as a form of payment according to rules established by certain card associations, and 5) provides reporting back to the organization about the card transactions.

Typically there are three different types of transaction data that may be reported to a purchasing cardholder. “Level I” data includes only the information that appears on a standard credit card statement, such as the transaction amount, transaction date, merchant name, and city/state of the merchant. “Level II” data includes buyer information, tax amount, the supplier organization's ZIP code, and the supplier organization's tax identification information. “Level III” purchasing card data is the most detailed transaction data available, and includes detail on each line item in a purchase, such as item description, product codes, quantity, unit-of-measure, price, delivery zip codes, freight charges, and sales tax information. Level III data is valuable for purchasing organizations, as it can be useful for streamlining the accounting processes and easily merging purchase data with their internal electronic procurement files.

Although Level III data may be very useful to organizations for reconciliation purposes, unfortunately it is not available a majority of the time because the transmission of Level III data requires the supplier and supplier's acquirer or processor to be set up to handle Level III data. While some supplying organizations and their acquirers or processors have the capability to provide level III data, most do not.

Even assuming that Level III data is reported to the buying organization, however, there exists no system for automated integration of Level III P-Card data into an organization's internal systems such as its Enterprise Resource Planning (“ERP”) system or Accounts Payable (“A/P”) system. Accordingly, organizations are forced to manually re-key invoice data, match it with the card transaction for reconciliation purposes, and then manually enter the data into the organization's ERP or A/P system.

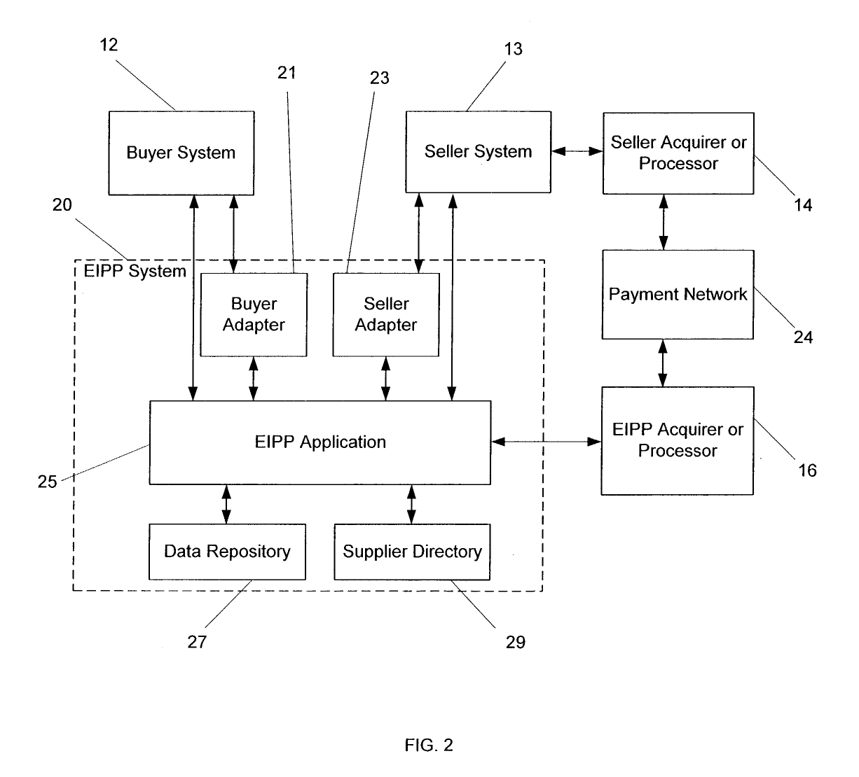

Referring now to FIG. 2, an exemplary embodiment of a system for conducting a transaction in conjunction with an exemplary embodiment of the EIPP system 20 in accordance with the present invention will now be described. The system includes the buyer system 12 (which includes a buyer's enterprise resource and procurement (ERP) system and/or a buyer's accounts payable (A/P) system) and a seller system 13 (which includes a seller's enterprise resource and procurement (ERP) system and/or a seller's accounts receivable (A/R) system). Both the buyer's system and the seller's system are coupled to an EIPP system 20 according to the present invention. The seller system may be coupled to seller payment card acquirer bank or processor 14 (hereinafter “Seller Acquirer”) through, for example, a point-of-sale (POS) terminal. The Seller Acquirer 14 is coupled to a payment network (such as the MasterCard payment network).

The EIPP system 20 includes an EIPP application 25 which is coupled to a buyer adapter software module 21, a seller adapter software module 23, a payment card data repository 27, and a supplier directory 29. The buyer adapter software module 21 translates purchase order information created by the buyer's ERP and/or A/P systems to a format usable by the EIPP application 25. The seller adapter software module 23 translates invoice information created by the buyer's ERP and/or A/R systems to a format usable by the EIPP application 25. The buyer adapter 21 may be installed at the buyer's organization and the seller adapter may 23 be installed at the seller's organization. The payment card data repository 27 receives and stores transaction information related to payment card information. This repository may be, for example, the MasterCard Global Data Repository, which receives and stores commercial and purchasing card transactional data. The supplier directory 29 contains a profile of each seller. The profile may include information indicating the types of payment the seller accepts, seller ID information, etc. Using the supplier directory 29, the buyer 12 may easily determine which suppliers are registered to use the EIPP system 20. The EIPP system 20 may be coupled to an acquirer bank or processor 16 (hereinafter “EIPP Acquirer”).

The EIPP system 20 may include a wide variety of computer elements, such as personal computers, web servers, databases, and software applications for performing the required operations in accordance with the present invention. The data files created, stored and transferred by the EIPP system may be in numerous formats depending on the particular implementation. In one exemplary embodiment of the EIPP system according to the present invention, the system may store files in Extensible Markup Language (“XML”), a format which provides a flexible means for creating and sharing common information between systems. Furthermore, the EIPP system according to the present invention may utilize numerous different file transfer methods for transferring data to the organizations' systems 12, 13 and the data repository 27. These may include HTTPS File Transfer and MasterCard File Express (“MFE”). It should be noted that the present invention is not limited to implementations using the technologies described herein. Those skilled in the art will understand that the systems and methods of the present invention may be implemented using numerous different interchangeable computer, communications and software technologies within the scope of the invention.

Preferably, the buyer organization and supplier organization are registered with the EIPP system. In addition, the parties may have reached an agreement as to payment terms (such as net 30 days), and those terms reside in the buyer organization's electronic procurement/ERP system; however, it is not necessary for the parties to have agreed upon such terms for the operation of the presently claimed invention. Additionally, the supplier organization's profile is established in the EIPP supplier directory, and may include information related to the supplier organization's ability to accept particular types of payments, such as MasterCard purchasing cards.

Advantageously, the EIPP system 20 allows buyers to preserve their PO requisition and approval process (i.e., does not require changes to existing systems or processes) and pay for the transaction with a payment card, such as their MasterCard Purchasing Card. For the purposes of the following discussion, it will be assumed that the payment card is a P-Card, but it will be understood that the invention may utilize any payment card.

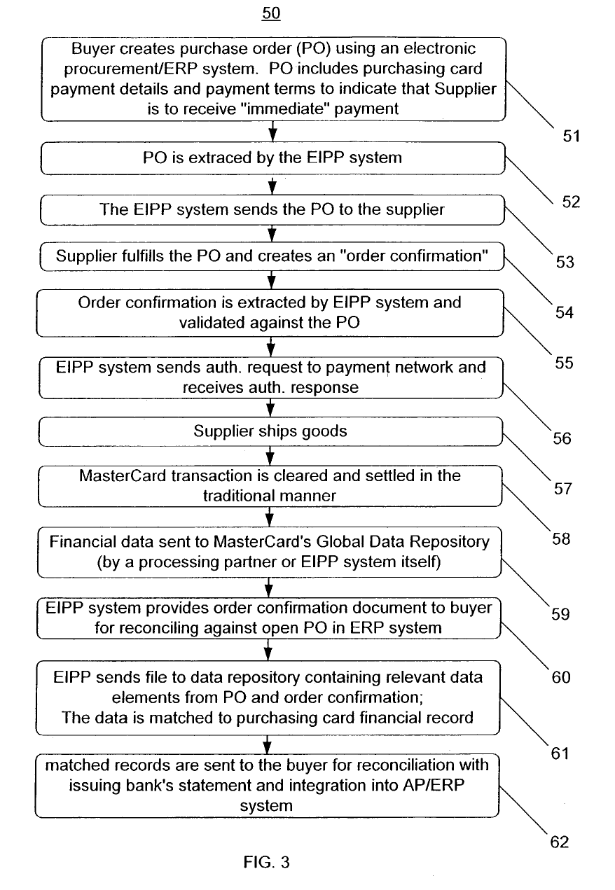

FIGS. 3 to 5 illustrate three different scenarios including P-Card settlement according to the presently claimed invention: 1) immediate P-Card settlement with purchase order; 2) delayed/scheduled P-Card settlement with purchase order; and 3) delayed/scheduled P-Card settlement without purchase order.

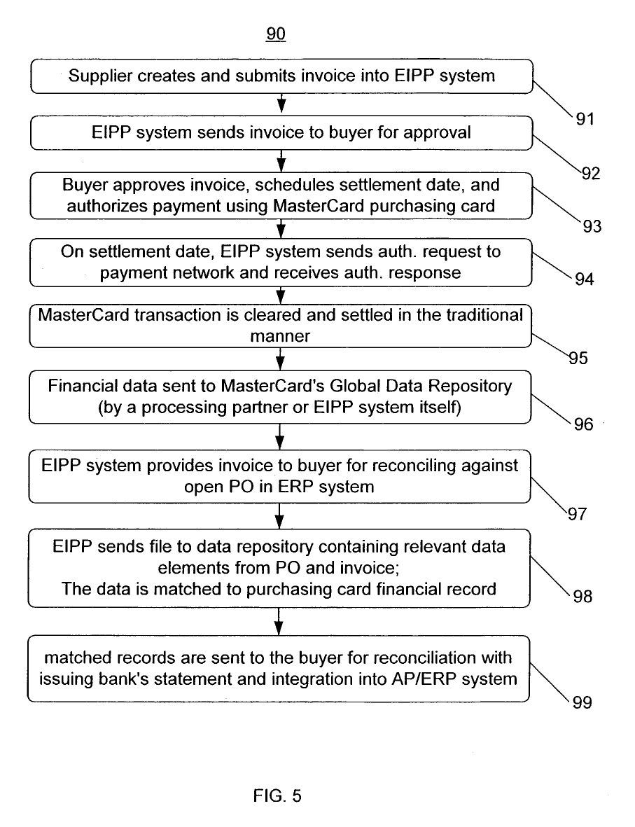

Before going into the detailed steps of FIGS. 5 to 7, it may be helpful to understand generally the difference between “immediate” and “delayed” (or “scheduled”) settlement. The immediate P-Card scenario is when the supplier (or acquirer/processor) is able to process the P-Card transaction once a PO is turned (“flipped”) into an order confirmation and submitted. The supplier does not have to submit an invoice and wait for approval. The immediate P-Card PO has been pre-approved for payment by the buyer, contingent upon the supplier shipping the goods and submitting an order confirmation. In the delayed P-Card scenario, the supplier is not able to process the P-Card transaction until a P-Card approved invoice has reached a buyer-determined settlement date. A delayed P-Card purchase can originate with a P-Card PO or without a PO. In either case, the submitted invoice from the supplier must go through the invoice approval process first. Once the invoice is approved by the buyer and the settlement date has been reached, the P-Card transaction can be processed by the supplier.

Immediate P-Card Settlement with Purchase Order

Referring to FIG. 3, in step 51, the buyer creates a purchase order (PO) using its electronic procurement/ERP and/or A/P system. The purchase order includes P-card account information and may include other payment details, including, for example in this instance, payment terms to indicate that the supplier organization is to receive “immediate” payment. In step 52, the purchase order information is communicated to the EIPP application via the buyer adapter.

The EIPP system then sends a purchase order or a notification to the supplier organization in step 53. In step 54, the supplier organization views the purchase order and creates an “order confirmation.” Importantly, the purchase card information is masked (either completely or partially) at this point. The order confirmation may be created by “flipping” the PO—i.e., pressing a button that transfers the information on the PO into an order confirmation. Once the PO is flipped, the seller may make edits to the order confirmation. Once the seller has finished with the edits, if any, the seller may submit the order confirmation to the EIPP system. The order confirmation is extracted by the EIPP system and validated against the purchase order and buyer data validation rules in step 55. Functionally, an order confirmation looks and behaves like an invoice. It goes through the same data validation (buyer defined) as an invoice. The presentation is the same as an invoice, but with a different title, and it does not require approval from the buyer. When the buyer validation rules are satisfied, the P-card information on the PO and order confirmation become unmasked and available to the seller, and the order confirmation becomes available to the buyer.

In step 56, payment is processed either by the seller or by the EIPP system. If payment is processed by the seller, the seller uses the P-card account information to conduct a P-card transaction through its Seller Acquirer. If payment is processed by the EIPP system, the EIPP system conducts a P-card transaction through the EIPP Acquirer. In each case, an authorization request is sent through the payment card network and an authorization response is received. Assuming the transaction is authorized, the supplier organization ships the goods to the buyer organization in step 57. The MasterCard transaction is then cleared and settled in the traditional manner in step 58.

The financial data record which is generated during the purchasing card payment and settlement process is then preferably sent to a data repository, such as MasterCard's Global Data Repository, in step 59. The EIPP system then provides order confirmation information to the buyer organization in step 60 for reconciling against open PO in buyer organization's electronic procurement/ERP systems.

In step 61, the EIPP application then sends the relevant data from the purchase order and order confirmation to the data repository, where this transaction data is matched with the corresponding purchasing card financial data record. Alternatively, the purchasing card financial data record may be transferred from the data repository to the EIPP application, and the EIPP application may perform this matching function. The matching function is preferably based on at least two unique match keys: a unique number generated by the EIPP system and the authorization response code for the P-card transaction. The matched data provides Level III details, regardless of supplier or acquirer limitations. In a final step 62, the matched records are sent to the buyer organization for reconciliation with the issuing bank's statement and integration into the buyer organization's AP/ERP systems. Preferably, the matched (enhanced) data resides in the MasterCard Global Central Data Repository and is available for delivery back to the buyer via secure, Web-based reporting tools, such as MasterCard Smart Data OnLine.

Delayed/Scheduled P-Card Settlement with Purchase Order

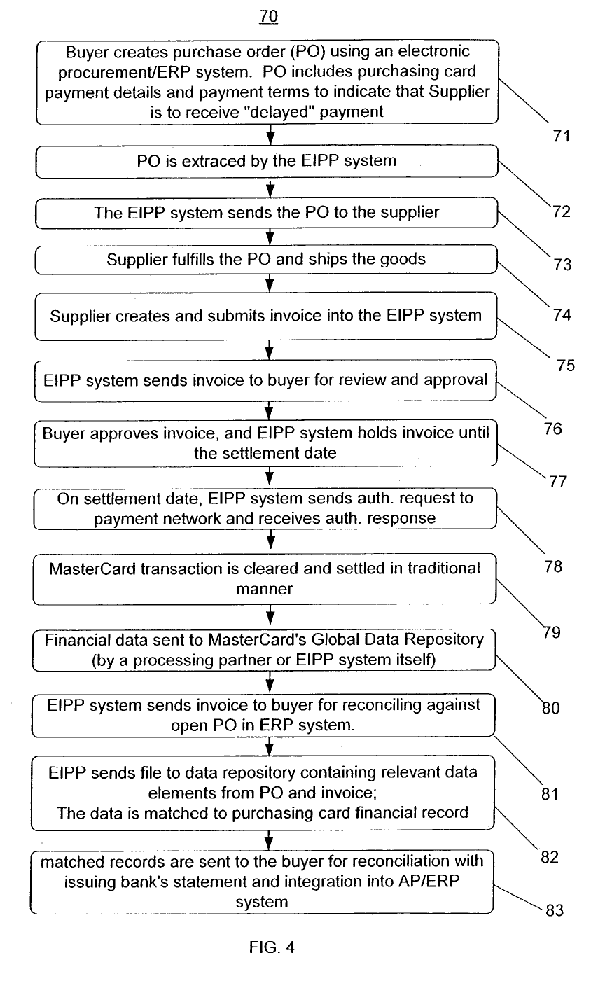

Referring to FIG. 4, a method 70 in accordance with an exemplary embodiment of the present invention will now be described. In this scenario, as in that described with respect to FIG. 3, the buyer organization and supplier organization are registered with the EIPP system, and the parties may (or may not) have reached an agreement as to payment terms. Again, the supplier organization's profile is established in the EIPP supplier directory. In step 71, the buyer creates a purchase order that includes various purchasing card payment details. In this instance, the purchase order contains payment terms to indicate that the supplier organization is to receive “delayed” payment. The PO may also include-purchase terms such as, for example, “net 30 days.” In step 72, the purchase order is extracted by the EIPP system via the buyer adapter. The EIPP system then sends the purchase order or a notification to the supplier organization in step 73. Importantly, as before, the purchase card information is masked (either completely or partially) at this point. In step 74, the supplier organization fulfills the purchase order and ships the goods. The supplier organization then creates and submits an invoice into the EIPP system in step 75. The invoice may be created through the EIPP application or may be created through the seller's ERP or A/R systems and communicated to the EIPP application. The invoice is checked against buyer validation rules. Subsequently in step 76 the EIPP system transmits the invoice or a notification to the buyer organization. In step 77, the buyer organization approves the invoice, and the EIPP then holds the invoice until the settlement date, which is determined by the buyer. “Holding” in this case means that the payment card information is not revealed or unmasked until the settlement date and/or that the EIPP system does not process the payment card transaction until the settlement date.

On the settlement date, the EIPP system reveals or unmasks the P-card account information. Either the seller or the EIPP may then use the information to process the payment. If the seller processes the payment, the seller sends an authorization request to its acquirer (for example, through a POS). The seller's acquirer sends it through the payment network and subsequently the seller receives an authorization response. If payment is processed by the EIPP system, the EIPP system conducts a P-card transaction through the EIPP Acquirer.

Assuming the transaction is authorized, the transaction is then cleared and settled in the traditional manner in step 79. The financial data record is then sent to a data repository, through methods known in the art, such as MasterCard's Global Data Repository, in step 80. In step 81, the EIPP system provides the invoice to the buyer organization for reconciliation against an open purchase order in the buyer organization's electronic procurement/ERP system. In step 82, the EIPP then sends data elements from the purchase order and invoice to the data repository, where this transaction data is matched with the corresponding purchasing card financial data record as previously described. Alternatively, the purchasing card financial data record may be transferred from the data repository to the EIPP system, and the EIPP system may perform this matching function. In a final step 83, the matched records are sent to the buyer organization for reconciliation with the issuing bank's statement and integration into the buyer organization's AP/ERP systems. The matched data provides Level III details, regardless of supplier or acquirer limitations. Preferably, the matched (enhanced) data resides in the MasterCard Global Central Data Repository and is available for delivery back to the buyer via secure, Web-based reporting tools, such as MasterCard Smart Data OnLine.

Delayed/Scheduled P-Card Settlement without Purchase Order.

Sometimes a transaction may occur without a purchase order. This may happen if the order is initiated through a telephone call, for example. Referring to FIG. 5, a flow chart describing another method 90 in accordance with an exemplary embodiment of the presently claimed invention is shown. FIG. 5 describes a transaction in which no purchase order is generated by the buyer, but rather where the transaction is initiated when the supplier organization submits an invoice to the buyer organization. In this scenario, as before, the buyer organization and supplier organization may or may not have reached an agreement as to payment terms. In step 91, the supplier organization initiates the transaction by creating and submitting an invoice into the EIPP system. The invoice may be created through the EIPP application or may be created through the seller's ERP or A/R systems and communicated to the EIPP application. The invoice is checked against buyer validation rules. In step 92, the EIPP system transmits the invoice to the buyer organization for approval. In step 93, the buyer organization approves the invoice, schedules a settlement date, and authorizes payment using a payment card such as the MasterCard P-Card. Once the invoice is approved, it may become visible to the seller; however, the P-card account information will be masked or hidden until the settlement date. In step 94, on the settlement date, the EIPP system or the seller sends an authorization request through its acquirer to the payment network and receives an authorization response. The MasterCard transaction is then cleared and settled in the traditional manner in step 95.

The appropriate financial data is then sent to a data repository in step 96. In step 97, the EIPP system provides the invoice to the buyer organization for reconciliation in the buyer organization's electronic procurement/ERP system. In step 98, the EIPP then sends the relevant data elements from the purchase order and invoice to the data repository, and this transaction data is then matched with the corresponding purchasing card financial data record as described before. In a final step 99, the matched records are sent to the buyer organization for reconciliation with the issuing bank's statement and integration into the buyer organization's AP/ERP systems. The matched data provides Level III details, regardless of supplier or acquirer limitations. Preferably, the matched (enhanced) data resides in the MasterCard Global Central Data Repository and is available for delivery back to the buyer via secure, Web-based reporting tools, such as MasterCard Smart Data OnLine.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

We claim:

1. A method for presenting and payment of an electronic invoice generated in connection with a purchase transaction between a buyer and a seller, including the steps of:
receiving a purchase order from the buyer, the purchase order including payment card account information and settlement date information;
receiving an invoice from the seller related to the purchase order;
receiving an indication of approval of the invoice from the buyer; and
masking the payment card account information, in whole or in part, from the seller until the settlement date.

2. A method for presenting and payment of an electronic invoice generated in connection with a purchase transaction between a buyer and a seller, including the steps of:
receiving an invoice from a seller;
receiving an indication of approval of the invoice from the buyer, including payment card account information and settlement date information; and
masking the payment card account information, in whole or in part, from the seller until the settlement date.

3. A method for presenting and payment of an electronic invoice generated in connection with a purchase transaction between a buyer and a seller, including the steps of:
receiving a purchase order from the buyer, the purchase order including payment card account information;
receiving an order confirmation or invoice from the seller related to the purchase order;
validating the order confirmation or invoice against predetermined buyer-defined rules; and
masking the payment card account information, in whole or in part, from the seller until the order confirmation or invoice has successfully satisfied the buyer-defined rules.

4. A method for presenting and payment of an electronic invoice generated in connection with a purchase transaction between a buyer and a seller, including the steps of:
receiving a purchase order from the buyer, the purchase order including payment card account information, the payment card account information being used to provide payment for the transaction through a payment network;
receiving an order confirmation or invoice from the seller related to the purchase order; and
matching information in the purchase order, order confirmation or invoice, and payment record for the payment card transaction to provide Level III data.

5. A method for presenting and paying an electronic invoice generated in connection with a purchase transaction between a buyer having a buyer's system and a supplier, and for capturing detailed data related to said transaction, comprising providing an electronic invoice presentment and payment system for receiving an electronic purchase order from said buyer and transmitting said purchase order information to said supplier, said purchase order including information related to said transaction and to proposed payment for said transaction using a payment card.

6. A method for presenting and paying an electronic invoice generated in connection with a purchase transaction between a buyer having a buyer's system and a supplier, and for capturing detailed data related to said transaction, comprising the steps of:
providing an electronic invoice presentment and payment system (EIPPS) for receiving an electronic purchase order from said buyer and transmitting said purchase order to said supplier, said purchase order including information related to said transaction and to proposed payment for said transaction using a purchasing card;
receiving from said supplier by said EIPPS an electronic invoice;
transmitting data related to said information to a payment card network for authorization of said transaction;
matching by said EIPPS at least one of said purchase order and said invoice with a record provided by said payment card network; and
storing by said EIPPS said detailed data related to said transaction and in integrating at least a portion of said detailed data into said buyer's system.

7. The method of claim 6, further comprising the step of presenting by said EIPPS said invoice to said buyer for approval.

8. The method of claim 6, further comprising the step of generating said electronic invoice by automatically extracting data from said electronic purchase order to populate data in said electronic invoice.

9. The method of claim 6, further comprising the step of, before receiving said invoice from said supplier, sending said purchase order to a real time process partner to establish an authorization control record.

10. The method of claim 9, further comprising the step of validating said transaction using said authorization control record.

11. The method of claim 6, further comprising the step of providing information about said supplier in a supplier directory.

12. The method of claim 6, wherein the payment of said invoice is completed using an electronic payment service.

13. The method of claim 6, wherein said detailed data comprises Level III data.

14. A method for presenting and paying an electronic invoice generated in connection with a purchase transaction between a buyer and supplier, and for capturing detailed data related to said transaction, comprising the steps of:
facilitating generation of an electronic invoice by said supplier using an electronic invoice presentment and payment system (EIPPS);
receiving said electronic invoice from said supplier's system by said EIPPS;
transmitting said electronic invoice from said EIPPS to said buyer;
transmitting data associated with said transaction to a payment network to facilitate an electronic payment of said electronic invoice from said buyer to said supplier;
matching data comprising data from said electronic invoice to a financial record of said electronic payment; and
automatically integrating said detailed data related to said transaction into said buyer's system.

15. The method of claim 14, further comprising the step of, before facilitating generation of an electronic invoice, receiving an electronic purchase order from said buyer by said EIPPS.

16. The method of claim 15, further comprising the step of, after receiving said electronic purchase order from said buyer, transmitting said purchase order to said supplier from said EIPPS.

17. The method of claim 14, further comprising the step of submitting said electronic invoice to said buyer for approval.

18. The method of claim 14, wherein the electronic invoice is an order confirmation which does not require approval of the buyer.

19. The method of claim 14, wherein the step of facilitating generation of said electronic invoice comprises automatically extracting data from said electronic purchase order to populate data in said electronic invoice.

20. The method of claim 14, further comprising the step of, after sending said purchase order to said EIPPS, sending said purchase order to a real time process partner to establish an authorization control record.

21. The method of claim 20, further comprising the step of validating said transaction using said authorization control record.

22. The method of claim 14, further comprising the step of providing information about said supplier in a supplier directory.

23. The method of claim 14, wherein the payment of said electronic invoice is completed using a purchasing card.

24. The method of claim 14, wherein said electronic invoice comprises Level III data.

25. A system for presenting and paying an electronic invoice, and for completing an electronic purchase transaction between a buyer and a supplier, comprising:
a first adapter subsystem coupled to a buyer organization financial system;
a second adapter subsystem coupled to a supplier organization financial system;
an Electronic Invoice Presentment and Payment System (EIPPS) coupled to said first adapter subsystem and said second adapter subsystem; and
a data repository coupled to said EIPPS.

26. The system of claim 25, further comprising a supplier directory coupled to said EIPPS.
